(19) United States
(12) Patent Application Publication
(10) Pub. No.: US 2026/0153389 A1
(43) Pub. Date: Jun. 4, 2026

(54) DETECTION DEVICE

(71) Applicant: Japan Display Inc., Tokyo (JP)

(72) Inventors: Yosuke HYODO, Tokyo (JP); Takumi SANO, Tokyo (JP)

(21) Appl. No.: 19/405,735

(22) Filed: Dec. 2, 2025

(30) Foreign Application Priority Data
Dec. 3, 2024 (JP) 2024-209994

(51) Int. Cl. G01L 1/22

(52) U.S. Cl. CPC G01L 1/2287

(57) ABSTRACT

According to an aspect, a detection device includes an array substrate and a sensor layer stacked in order. The array substrate includes: a first surface facing the sensor layer; and a plurality of detection electrodes provided to the first surface and separated from the sensor layer. The detection electrodes include a plurality of aperture detection electrodes each having an aperture through which the first surface is exposed. The aperture detection electrodes include two or more types of the aperture detection electrodes, each type having a different number of the apertures.

### CROSS-REFERENCE TO RELATED APPLICATION

This application claims the benefit of priority from Japanese Patent Application No. 2024-209994 filed on December 3, 2024, the entire contents of which are incorporated herein by reference.

### BACKGROUND

### 1. Technical Field

What is disclosed herein relates to a detection device.

### 2. Description of the Related Art

It is known that there are detection devices that detect a load (force) acting vertically on a detection surface. Such a detection device includes a protective layer, a sensor layer, and an array substrate stacked in this order from the detection surface. One surface of the protective layer serves as the detection surface. The array substrate described in Japanese Patent Application Laid-open Publication No. 2023-109115 includes detection electrodes and common electrodes disposed on the surface facing the sensor layer. The sensor layer has a contact surface that faces and is separated from each of the detection electrodes and the common electrodes. When force is applied to the detection surface, the contact surface moves toward the detection electrode and the common electrode and comes into contact with the detection electrode and the common electrode. As a result, a current flows from the common electrode to the detection electrode via the sensor layer. When the force applied to the detection surface is large, the contact area of the contact surface in contact with the common electrode and the detection electrode increases. As a result, the current flowing from the common electrode to the detection electrode increases.

The force applied to the detection device may be large or small. Therefore, it is desirable to be able to achieve both a wide force-sensing range to detect large force and a narrow force-sensing range to detect small force with high accuracy.

For the foregoing reasons, there is a need for a detection device including detection electrodes with different force-sensing ranges.

### SUMMARY

According to an aspect, a detection device includes an array substrate and a sensor layer stacked in order. The array substrate includes: a first surface facing the sensor layer; and a plurality of detection electrodes provided to the first surface and separated from the sensor layer. The detection electrodes include a plurality of aperture detection electrodes each having an aperture through which the first surface is exposed. The aperture detection electrodes include two or more types of the aperture detection electrodes, each type having a different number of the apertures.

According to another aspect, a detection device includes an array substrate and a sensor layer stacked in order. The array substrate includes: a first surface facing the sensor layer; and a plurality of detection electrodes provided to the first surface and separated from the sensor layer. The detection electrodes include a plurality of protrusion detection electrodes each having a protrusion protruding toward the sensor layer. The protrusion detection electrodes include two or more types of the protrusion detection electrodes, each type having a different number of the protrusions.

### BRIEF DESCRIPTION OF THE DRAWINGS

FIG. 1 is a schematic front view of a detection device according to a first embodiment;

FIG. 2 is a schematic of a section of the detection device according to the first embodiment, and more specifically a schematic sectional view along line II-II of FIG. 4;

FIG. 3 is an enlarged view of part (four individual detection regions) of a first surface of an array substrate according to the first embodiment viewed from a sensor layer;

FIG. 4 is an enlarged view of part (one individual detection region) of the first surface of the array substrate according to the first embodiment viewed from the sensor layer;

FIG. 5 is a circuit diagram of a circuit configuration of the detection device according to the first embodiment;

FIG. 6 is a sectional view schematically illustrating a state where force is applied to the individual detection region provided with a flat detection electrode in the detection device according to the first embodiment;

FIG. 7 is a sectional view schematically illustrating a state where force is applied to the individual detection region provided with an aperture detection electrode (third aperture detection electrode) in the detection device according to the first embodiment;

FIG. 8 is a graph indicating the relation between force applied to a detection surface and the amount of current flowing to the detection electrode in the detection device according to the first embodiment;

FIG. 9 is a sectional view of the detection device according to a second embodiment along a stacking direction, and more specifically a schematic of a section along line IX-IX of FIG. 10;

FIG. 10 is an enlarged view of part (four individual detection regions) of the first surface of the array substrate according to the second embodiment viewed from the sensor layer;

FIG. 11 is a sectional view of a state where force is applied to the individual detection region provided with a protrusion detection electrode in the detection device according to the second embodiment; and

FIG. 12 is a graph indicating the relation between the force applied to the detection surface and the amount of current flowing to the detection electrode in the detection device according to the second embodiment.

### DETAILED DESCRIPTION

Exemplary aspects (embodiments) to embody a detection device according to the present disclosure are described below in greater detail with reference to the accompanying drawings. The contents described in the embodiments are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present disclosure and easily conceivable by those skilled in the art naturally fall within the scope of the present disclosure. To simplify the explanation, the drawings may possibly illustrate the width, the thickness, the shape, and other elements of each unit more schematically than those in the actual aspect. These elements, however, are given by way of example only and are not intended to limit interpretation of the present disclosure. In the present specification and the drawings, components similar to those previously described with reference to previous drawings are denoted by the same reference numerals, and detailed explanation thereof may be appropriately omitted.

To describe an aspect regarding a certain structure on which or above which another structure is disposed in the present specification and the claims, when "on" is simply used, it indicates both the following cases unless otherwise noted: a case where the other structure is disposed directly on and in contact with the certain structure, and a case where the other structure is disposed above the certain structure with yet another structure interposed therebetween.

### First Embodiment

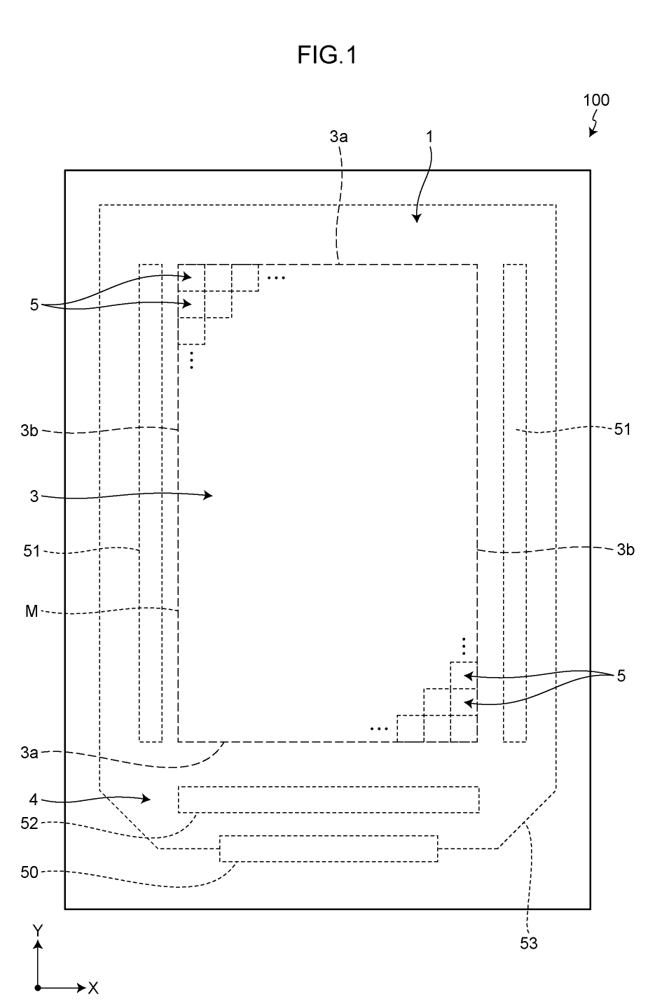

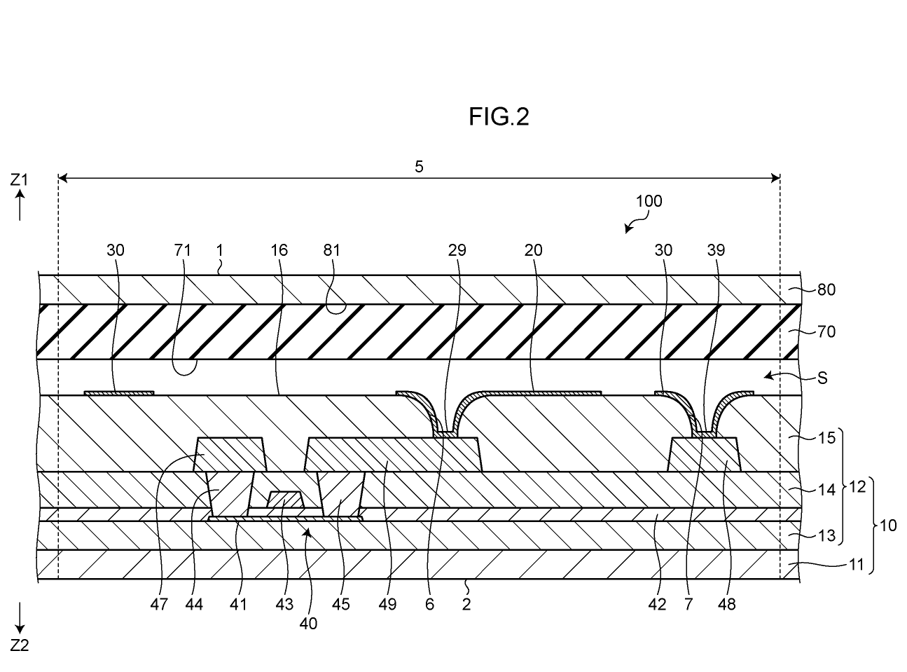

FIG. 1 is a schematic front view of a detection device according to a first embodiment. A detection device 100 is a device that detects force acting on a detection surface 1. As illustrated in FIG. 1, the detection device 100 is formed in a flat plate shape. The detection device 100 has a flat front surface (detection surface 1) and a flat back surface 2 (not illustrated in FIG. 1; refer to FIG. 2). The detection device 100 has a rectangular shape when viewed along the direction normal to the detection surface 1. The detection device 100 illustrated in FIG. 1 has the flat detection surface 1, so it can detect force distribution in the detection surface 1.

The detection surface 1 is divided into a detection region 3 in which force can be detected and a peripheral region 4 in which force cannot be detected. The detection region 3 is positioned at the center of the detection surface 1. The peripheral region 4 is formed in a frame shape and surrounds the outer periphery of the detection region 3.

The detection region 3 is formed in a rectangular shape when viewed along the direction normal to the detection surface 1. Therefore, an outer frame M of the detection region 3 has a pair of short sides 3a and a pair of long sides 3b. In the following description, the direction parallel to the detection surface 1 and parallel to the short side 3a is referred to as a first direction X. The direction parallel to the detection surface 1 and parallel to the long side 3b is referred to as a second direction Y. Thus, the second direction Y is a direction orthogonal to (intersecting) the first direction X. The direction parallel to the detection surface 1 may be hereinafter referred to as a planar direction.

The detection region 3 is divided into a plurality of individual detection regions 5. In other words, the detection region 3 is composed of the individual detection regions 5. A force value is detected in each of the individual detection regions 5. When viewed along the direction normal to the detection surface 1, the individual detection region 5 has a square shape. The individual detection regions 5 are arrayed in the first direction X and the second direction Y.

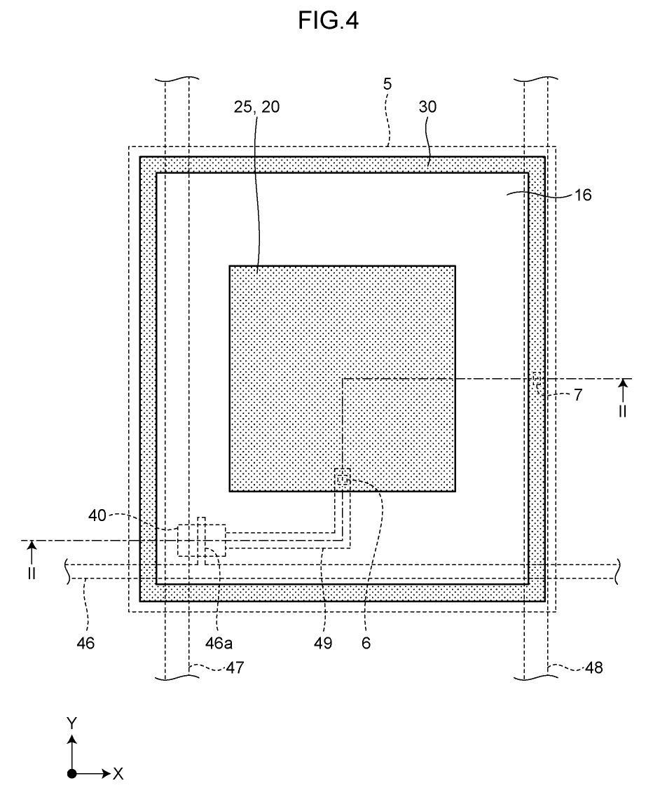

FIG. 2 is a schematic of a section of the detection device according to the first embodiment, and more specifically a schematic sectional view along line II-II of FIG. 4. As illustrated in FIG. 2, the detection device 100 includes an array substrate 10, a sensor layer 70, and a protective layer 80 stacked in this order. In the following description, the direction in which the array substrate 10, the sensor layer 70, and the protective layer 80 are stacked is referred to as a stacking direction. The direction normal to the detection surface 1 described above is the same meaning as the stacking direction. In the stacking direction, the direction in which the sensor layer 70 is disposed when viewed from the array substrate 10 is referred to as a first stacking direction Z1, and the direction opposite thereto is referred to as a second stacking direction Z2. Viewing from the first stacking direction Z1 is referred to as plan view.

The array substrate 10 includes a base 11 and an array layer 12 formed in the first stacking direction Z1 with respect to the base 11. The base 11 is a plate-like member that supports the array layer 12 and has an insulating property. While the base 11 is a flexible substrate made of polyimide, for example, the present disclosure is not limited thereto. The surface of the base 11 facing in the second stacking direction Z2 serves as the back surface 2 of the detection device 100.

The array layer 12 includes a first insulating layer 13, a second insulating layer 14, and a third insulating layer 15 stacked in this order on the surface of the base 11 facing in the first stacking direction Z1. The space between the first insulating layer 13 and the second insulating layer 14 is provided with a gate insulating film 42 of a transistor 40, which will be described later.

The first insulating layer 13, the second insulating layer 14, and the third insulating layer 15 are made of insulating material. The insulating material may be either inorganic or organic material. The third insulating layer 15 is a layer (planarization film) for planarizing a first surface 16 of the array layer 12 in the first stacking direction Z1. While the array layer 12 according to the present embodiment includes three insulating layers, the number of insulating layers according to the present disclosure is not particularly limited.

The first surface 16 of the array layer 12 is provided with detection electrodes 20 and common electrodes 30 and has first contact holes 6 and second contact holes 7. The detection electrode 20 and the common electrode 30 are metal films (metal layers) made of metal material, such as indium tin oxide (ITO), and formed on the first surface 16.

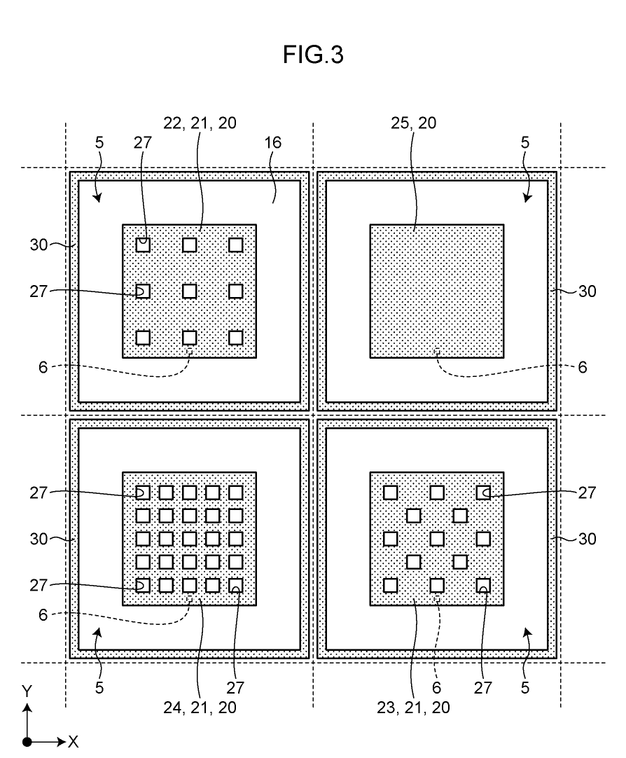

FIG. 3 is an enlarged view of part (four individual detection regions) of the first surface of the array substrate according to the first embodiment viewed from the sensor layer. FIG. 4 is an enlarged view of part (one individual detection region) of the first surface of the array substrate according to the first embodiment viewed from the sensor layer. In FIGS. 3 and 4, the detection electrodes 20 and the common electrodes 30 are shaded with dots to make them easier to see.

As illustrated in FIGS. 3 and 4, a plurality of the detection electrodes 20 are formed on the first surface 16. Each detection electrode 20 is disposed in a corresponding one of the individual detection regions 5. The detection electrode 20 is disposed at the center of the individual detection region 5. The outline of the detection electrode 20 has a square shape in plan view.

Some of the detection electrodes 20 have apertures 27. The aperture 27 penetrates the detection electrode 20 in the stacking direction. Therefore, the first surface 16 is exposed through the aperture 27. The aperture 27 has a square shape in plan view. The detection electrode 20 with the apertures 27 is hereinafter referred to as an aperture detection electrode 21.

A plurality of aperture detection electrodes 21 include those with different numbers of apertures 27. Specifically, the types of the aperture detection electrodes 21 include a first aperture detection electrode 22 with nine apertures 27, a second aperture detection electrode 23 with 13 apertures 27, and a third aperture detection electrode 24 with 25 apertures 27.

The detection electrodes 20 also include the detection electrode 20 with no apertures 27. The detection electrodes 20 with no apertures 27 are hereinafter referred to as flat detection electrodes 25. In the present embodiment, four adjacent individual detection regions 5 are defined as a set, and the four detection electrodes 20 disposed in the four individual detection regions 5 are the first aperture detection electrode 22, the second aperture detection electrode 23, the third aperture detection electrode 24, and the flat detection electrode 25.

As illustrated in FIGS. 3 and 4, a plurality of the common electrodes 30 are formed on the first surface 16. The common electrode 30 is formed in a square (quadrilateral) frame shape in plan view. Each common electrode 30 is disposed in a corresponding one of the individual detection regions 5. The detection electrode 20 is disposed inside the square frame of the common electrode 30, and the common electrode 30 surrounds the detection electrode 20. The common electrode 30 and the detection electrode 20 are separated in the planar direction and are not coupled to each other on the first surface 16.

The first contact hole 6 and the second contact hole 7 are holes extending from the first surface 16 of the array substrate 10 in the second stacking direction Z2 (refer to FIG. 2). As illustrated in FIG. 4, each first contact hole 6 and each second contact hole 7 are formed in one corresponding individual detection region 5. The first contact hole 6 is formed in a part of the first surface 16 covered by the detection electrode 20. The second contact hole 7 is formed in a part of the first surface 16 covered by the common electrode 30. As illustrated in FIG. 2, a part of the detection electrode 20 is disposed in the first contact hole 6 and serves as a first contact portion 29. A part of the common electrode 30 is disposed in the second contact hole 7 and serves as a second contact portion 39.

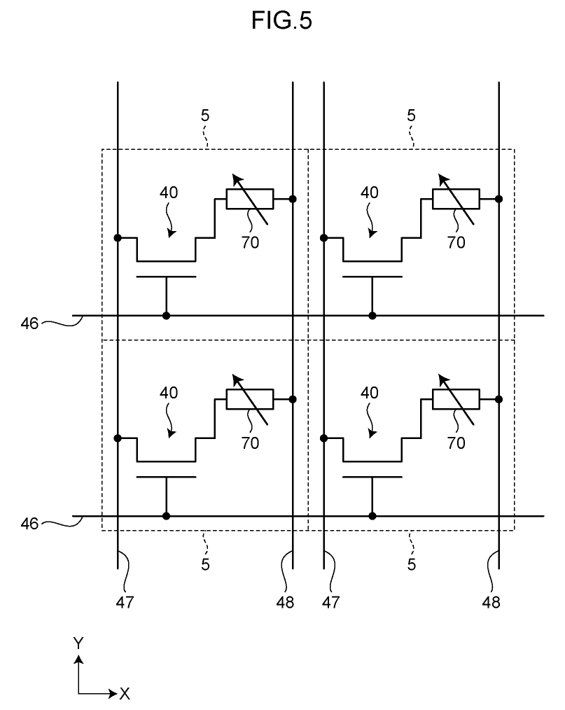

FIG. 5 is a circuit diagram of a circuit configuration of the detection device according to the first embodiment. As illustrated in FIG. 5, the array layer 12 is provided with a transistor 40, a gate line 46, a signal line 47, a reference potential line 48, a coupling member 50 (refer to FIG. 1), a gate line drive circuit 51 (refer to FIG. 1), a signal line selection circuit 52 (refer to FIG. 1), and a common line 53 (refer to FIG. 1). A plurality of the transistors 40, a plurality of the gate lines 46, a plurality of the signal lines 47, and a plurality of the reference potential lines 48 are formed in the array layer 12 (array substrate 10).

The transistor 40 is a switching element. The transistors 40 are provided to the respective individual detection regions 5. As illustrated in FIG. 2, the transistor 40 includes a semiconductor layer 41, the gate insulating film 42, a gate electrode 43, a drain electrode 44, and a source electrode 45. The end of the source electrode 45 in the first stacking direction Z1 is coupled to a coupling line 49. The coupling line 49 extends in the planar direction (refer to FIG. 4) and is coupled to the first contact portion 29. Therefore, the source electrode 45 is coupled to the detection electrode 20 via the coupling line 49 and the first contact portion 29.

As illustrated in FIG. 5, each of the gate lines 46 extends in the first direction X. The gate lines 46 are arrayed in the second direction Y. As illustrated in FIG. 4, the gate line 46 is provided with a branch 46a extending in the second direction Y. The branch 46a is provided to each individual detection region 5. The gate line 46 is coupled to the gate electrodes 43 (refer to FIG. 2) of the respective transistors 40 arrayed in the first direction X via the branches 46a.

As illustrated in FIG. 5, each of the signal lines 47 extends in the second direction Y. The signal lines 47 are arrayed in the first direction X. The signal line 47 is coupled to the drain electrodes 44 (refer to FIG. 2) of the respective transistors 40 arrayed in the second direction Y.

As illustrated in FIG. 5, each of the reference potential lines 48 extends in the second direction Y. The reference potential lines 48 are arrayed in the first direction X. As illustrated in FIG. 2, the reference potential line 48 is coupled to the second contact portion 39 of the common electrode 30.

As illustrated in FIG. 1, the coupling member 50, the gate line drive circuit 51, the signal line selection circuit 52, and the common line 53 are disposed in the peripheral region 4 in the array layer 12. The coupling member 50 couples the detection device 100 to a drive integrated circuit (IC) disposed outside the detection device 100. The drive IC may be mounted as a chip on film (COF) on a flexible printed circuit board or a rigid circuit board coupled to the coupling member 50. Alternatively, the drive IC may be mounted as a chip on glass (COG) in the peripheral region 4 of the array substrate 10.

The gate line drive circuits 51 are circuits that drives the gate lines 46 (refer to FIG. 5) based on various control signals from the drive IC. The gate line drive circuits 51 sequentially or simultaneously select the gate lines 46 and supply gate drive signals to the selected gate lines 46.

The signal line selection circuit 52 is a switch circuit that sequentially or simultaneously selects the signal lines 47 (refer to FIG. 5). The signal line selection circuit 52 is a multiplexer, for example. The signal line selection circuit 52 couples the selected signal lines 47 to the drive IC based on selection signal supplied from the drive IC. The detection region 3 is provided with the transistors 40, the gate lines 46, the signal lines 47, and the reference potential lines 48, so that the detection device 100 can measure changes over time in the force distribution in the plane.

The common line 53 is coupled to the drive IC via the coupling member 50 and is supplied with a certain amount of current from the drive IC. The common line 53 extends along the peripheral region and has an annular (frame-like) shape. The common line 53 is coupled to the reference potential line 48. Therefore, the common electrode 30 is supplied with a certain amount of current.

As illustrated in FIG. 2, the sensor layer 70 is made of resin material having conductivity (hereinafter referred to as conductive resin material) and has a flat plate shape. The sensor layer 70 is bonded to a surface 81 of the protective layer 80 in the second stacking direction Z2 and integrated with the protective layer 80. The surface of the sensor layer 70 in the second stacking direction Z2 serves as a contact surface 71. The contact surface 71 faces the first surface 16 of the array substrate 10. The contact surface 71 is separated from the detection electrodes 20 and the common electrodes 30. Thus, a space S is formed between the contact surface 71 and the first surface 16.

As illustrated in FIG. 2, the protective layer 80 is made of elastically deformable insulating material, such as rubber and resin. The surface of the protective layer 80 in the first stacking direction Z1 serves as the detection surface 1. The sensor layer 70 and the protective layer 80 integrally formed are bonded to the array substrate 10 with a frame member (not illustrated) interposed therebetween in the area overlapping the peripheral region 4.

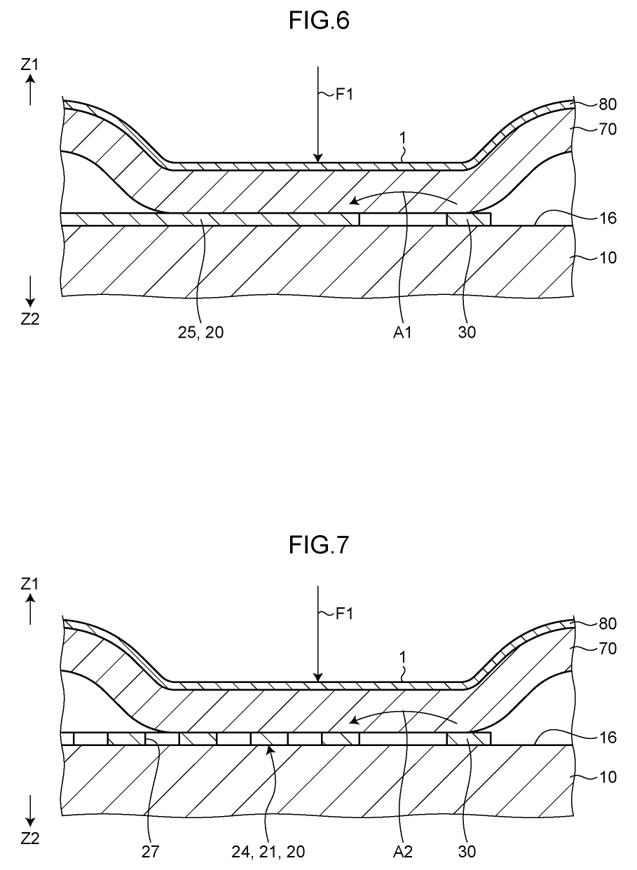

FIG. 6 is a sectional view schematically illustrating a state where force is applied to the individual detection region 5 provided with the flat detection electrode in the detection device according to the first embodiment. FIG. 7 is a sectional view schematically illustrating a state where force is applied to the individual detection region 5 provided with the aperture detection electrode (third aperture detection electrode) in the detection device according to the first embodiment. The following describes a case where force is applied to the individual detection region 5.

As illustrated in FIGS. 6 and 7, when force F1 is applied to the detection surface 1, the protective layer 80 and the sensor layer 70 in the individual detection region 5 to which the force F1 is applied deform in the second stacking direction Z2. Part of the contact surface 71 of the sensor layer 70 comes into contact with the detection electrode 20. As a result, a current flows from the common electrode 30 to the detection electrode 20 via the sensor layer 70 (refer to arrow A1 in FIG. 6 and arrow A2 in FIG. 7).

As the force F1 increases, the amount of deformation of the sensor layer 70 in the second stacking direction Z2 also increases. In other words, the contact area between the sensor layer 70 and the detection electrode 20 increases, and the amount of current flowing from the common electrode 30 to the detection electrode 20 also increases. The electrical signal (current value) input to the detection electrode 20 is output by the signal line 47 to the drive IC. Based on the magnitude of the current value, the drive IC derives the load input to the individual detection region 5.

As illustrated in FIG. 7, the aperture detection electrode 21 (third aperture detection electrode 24 is illustrated in FIG. 7) according to the present embodiment has a plurality of the apertures 27. With this structure, the aperture detection electrode 21 has a smaller contact area with the sensor layer 70 than the flat detection electrode 25 does when the same force is applied. Therefore, the amount of current flowing to the aperture detection electrode 21 (arrow A2 in FIG. 7) is smaller than the amount of current flowing to the flat detection electrode 25 (refer to arrow A1 in FIG. 6).

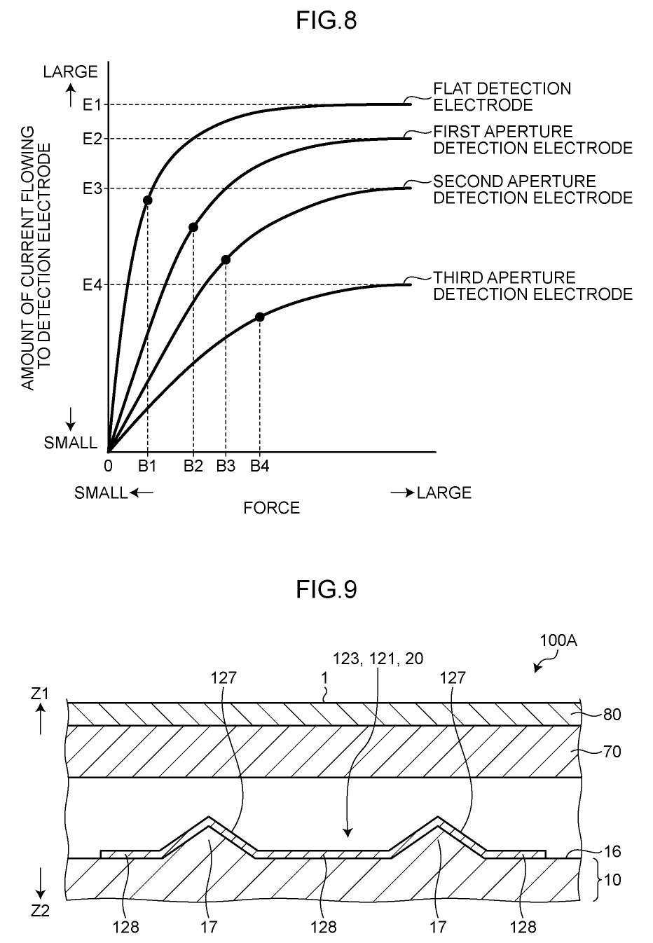

FIG. 8 is a graph indicating the relation between the force applied to the detection surface and the amount of current flowing to the detection electrode in the detection device according to the first embodiment. The following describes the relation between the contact area between the sensor layer 70 and the detection electrode 20 and the amount of current flowing to the detection electrode 20. When the contact area between the sensor layer 70 and the detection electrode 20 does not exceed a predetermined amount (threshold), the force and the amount of current are in such a proportional relation that the current flowing to the detection electrode 20 increases as the contact area between the sensor layer 70 and the detection electrode 20 increases. By contrast, when the contact area between the sensor layer 70 and the detection electrode 20 exceeds the predetermined amount (threshold), the ratio of increase in the amount of current, which flows to the detection electrode 20, with respect to the ratio of increase in the contact area is small, and the force and the amount of current are not proportional. To detect a force value, the range in which the force and the amount of current are proportional is used.

More specifically, as illustrated in FIG. 8, the force and the amount of current are proportional in the range where the force value input to the individual detection region 5 provided with the flat detection electrode 25 is from 0 (zero) to B1. By contrast, when the force value exceeds B1, the force and the amount of current are not proportional. In other words, the contact area with the sensor layer 70 reaches the threshold when the force value is B1 in the individual detection region 5 provided with the flat detection electrode 25. Therefore, the force-sensing range (magnitude of detectable force) of the individual detection region 5 provided with the flat detection electrode 25 is from 0 (zero) to B1.

By contrast, the first aperture detection electrode 22 has the apertures 27, and the contact area does not reach the threshold when the force value is B1. Therefore, the contact area with the sensor layer 70 reaches the threshold when the force value is B2, which is larger than B1, in the individual detection region 5 provided with the first aperture detection electrode 22. Thus, the force-sensing range of the individual detection region 5 provided with the first aperture detection electrode 22 is from 0 (zero) to B2.

The second aperture detection electrode 23 has more apertures 27 than the first aperture detection electrode 22 does, so the contact area with the sensor layer 70 does not reach the threshold when the force value is B2. The contact area with the sensor layer 70 reaches the threshold when the force value is B3, which is larger than B2, in the individual detection region 5 provided with the second aperture detection electrode 23. Thus, the force-sensing range of the individual detection region 5 provided with the second aperture detection electrode 23 is from 0 (zero) to B3.

The third aperture detection electrode 24 has more apertures 27 than the second aperture detection electrode 23 does, so the contact area with the sensor layer 70 does not reach the threshold when the force value is B3. Therefore, the contact area with the sensor layer 70 reaches the threshold when the force value is B4, which is larger than B3, in the individual detection region 5 provided with the third aperture detection electrode 24. Thus, the force-sensing range of the individual detection region 5 provided with the third aperture detection electrode 24 is from 0 (zero) to B4.

As described above, in the detection device 100 according to the first embodiment, the force-sensing range differs between the individual detection regions 5 provided with the flat detection electrode 25, the first aperture detection electrode 22, the second aperture detection electrode 23, and the third aperture detection electrode 24. The force-sensing range increases in the order of the flat detection electrode 25, the first aperture detection electrode 22, the second aperture detection electrode 23, and the third aperture detection electrode 24.

In addition, in the first embodiment, the aperture detection electrode 21 has the apertures 27 and has a smaller footprint area than the flat detection electrode 25 does in plan view. Therefore, the maximum amounts of current flowing to the respective detection electrodes 20 (refer to E1, E2, E3, and E4 on the vertical axis in FIG. 8) are not the same and decrease in the order of the flat detection electrode 25, the first aperture detection electrode 22, the second aperture detection electrode 23, and the third aperture detection electrode 24.

The first embodiment has been described above. While the aperture 27 according to the first embodiment has a square shape, the shape of the aperture according to the present disclosure is not particularly limited. While one of the four detection electrodes 20 according to the first embodiment is the flat detection electrode 25, all the four detection electrodes 20 according to the present disclosure may be the aperture detection electrodes 21. While the present embodiment has three types of the aperture detection electrodes 21 with different numbers of the apertures 27, the present disclosure simply needs to have two or more types. Next, a detection device 100A according to a second embodiment is described. The second embodiment describes only the differences from the first embodiment.

### Second Embodiment

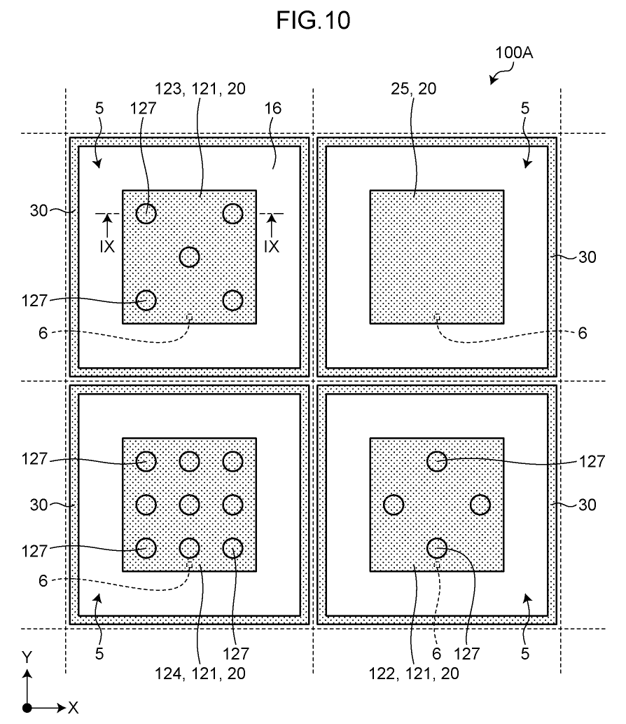

FIG. 9 is a sectional view of the detection device according to the second embodiment along the stacking direction, and more specifically a schematic of a section along line IX-IX of FIG. 10. FIG. 10 is an enlarged view of part (four individual detection regions) of the first surface of the array substrate according to the second embodiment viewed from the sensor layer. As illustrated in FIG. 9, a detection device 100A according to the second embodiment is different from the first embodiment in that a protrusion detection electrode 121 is provided instead of the aperture detection electrode 21.

As illustrated in FIG. 9, the first surface 16 of the array substrate 10 has base protrusions 17 protruding in the first stacking direction Z1. The base protrusion 17 is formed in the area overlapping the protrusion detection electrode 121. Therefore, the part of the protrusion detection electrode 121 stacked on the base protrusion 17 serves as a protrusion 127 protruding toward the sensor layer 70. The part of the protrusion detection electrode 121 stacked not on the base protrusion 17 but on the first surface 16 is referred to as a bottom 128.

The base protrusion 17 has a conical shape. Therefore, the protrusion 127 also has a conical shape. As illustrated in FIG. 10, the protrusion 127 has a circular shape in plan view.

As illustrated in FIG. 10, a plurality of the protrusion detection electrodes 121 include those with different numbers of the protrusions 127. Specifically, the types of the protrusion detection electrodes 121 include a first protrusion detection electrode 122 with four protrusions 127, a second protrusion detection electrode 123 with five protrusions 127, and a third protrusion detection electrode 124 with nine protrusions 127.

The following describes a case where force is applied to the individual detection region 5 provided with the protrusion detection electrode 121. In the following description, the second protrusion detection electrode 123 is used as a representative example of the protrusion detection electrode 121.

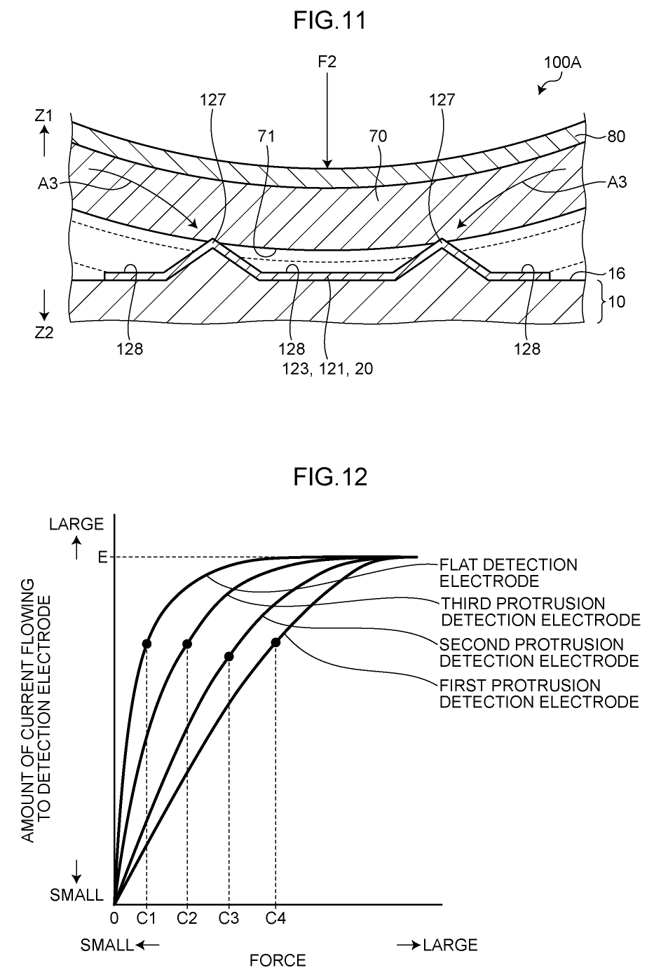

FIG. 11 is a sectional view of a state where force is applied to the individual detection region provided with the protrusion detection electrode in the detection device according to the second embodiment. As illustrated in FIG. 11, when force F2 is applied to the detection surface 1, the protective layer 80 and the sensor layer 70 deform in the second stacking direction Z2. The contact surface 71 of the sensor layer 70 thus comes into contact with the top of the protrusion 127 (end in the first stacking direction Z1). As a result, a current flows from the common electrode 30 (not illustrated in FIG. 11) to the second protrusion detection electrode 123 via the sensor layer 70 (refer to arrow A3 in FIG. 11).

As the force applied to the detection surface 1 increases, the sensor layer 70 further bends in the second stacking direction Z2 and comes into contact with the middle part of the protrusion 127 in the stacking direction. When the applied force further increases, the sensor layer 70 comes into contact with the entire protrusion 127 and the entire bottom 128, that is, the entire second protrusion detection electrode 123.

In the protrusion detection electrode 121 described above, when the sensor layer 70 bends in the second stacking direction Z2, it comes into contact with the protrusion 127 first. Therefore, the sensor layer 70 is less likely to come into contact with the bottom 128. For this reason, the protrusion detection electrode 121 has a smaller contact area with the sensor layer 70 than the flat detection electrode 25 does when the force of the same magnitude is applied.

Thus, in the second embodiment, when the force of the same magnitude is applied, the contact area between the detection electrode 20 and the sensor layer 70 decreases in the order of the flat detection electrode 25, the third protrusion detection electrode 124, the second protrusion detection electrode 123, and the first protrusion detection electrode 122. Next, the force-sensing ranges of the respective detection electrodes 20 are described.

FIG. 12 is a graph indicating the relation between the force applied to the detection surface and the amount of current flowing to the detection electrode in the detection device according to the second embodiment. As illustrated in FIG. 12, the contact area between the sensor layer 70 and the flat detection electrode 25 according to the second embodiment reaches the threshold when the force value is C1. Therefore, the force-sensing range (magnitude of detectable force) of the individual detection region 5 provided with the flat detection electrode 25 is from 0 (zero) to C1.

The third protrusion detection electrode 124 has the protrusions 127, and the contact area with the sensor layer 70 does not reach the threshold when the force value is C1. Therefore, the contact area with the sensor layer 70 reaches the threshold when the force value is C2, which is larger than C1, in the individual detection region 5 provided with the third protrusion detection electrode 124. Thus, the force-sensing range of the individual detection region 5 provided with the third protrusion detection electrode 124 is from 0 (zero) to C2.

The second protrusion detection electrode 123 has fewer protrusions 127 than the third protrusion detection electrode 124 does, so the contact area does not reach the threshold when the force value is C2. Therefore, the contact area with the sensor layer 70 reaches the threshold when the force value is C3, which is larger than C2, in the individual detection region 5 provided with the second protrusion detection electrode 123. Thus, the force-sensing range of the individual detection region 5 provided with the second protrusion detection electrode 123 is from 0 (zero) to C3.

The first protrusion detection electrode 122 has fewer protrusions 127 than the second protrusion detection electrode 123 does, so the contact area does not reach the threshold when the force value is C3. Therefore, the contact area with the sensor layer 70 reaches the threshold when the force value is C4, which is larger than C3, in the individual detection region 5 provided with the first protrusion detection electrode 122. Thus, the force-sensing range of the individual detection region 5 provided with the first protrusion detection electrode 122 is from 0 (zero) to C4.

As described above, in the detection device 100A according to the first embodiment, the force-sensing range differs between the individual detection regions 5 provided with the flat detection electrode 25, the first protrusion detection electrode 122, the second protrusion detection electrode 123, and the third protrusion detection electrode 124. The force-sensing range increases in the order of the flat detection electrode 25, the third protrusion detection electrode 124, the second protrusion detection electrode 123, and the first protrusion detection electrode 122.

The protrusion detection electrode 121 according to the second embodiment has the same footprint area as that of the flat detection electrode 25 in plan view (refer to FIG. 10). Therefore, the flat detection electrode 25 and the protrusion detection electrode 121 have the same maximum amount of current flowing to the detection electrode 20 (refer to E on the vertical axis in FIG. 12).

The second embodiment has been described above. While the protrusion 127 according to the second embodiment is a frustum (conical frustum), the protrusion according to the present disclosure may be a column (including cylinders and prisms), and the shape of the protrusion 127 is not particularly limited. While the protrusion 127 according to the second embodiment has a circular shape in plan view, the shape of the protrusion according to the present disclosure in plan view is not particularly limited. While one of the four detection electrodes 20 according to the second embodiment is the flat detection electrode 25, all the four detection electrodes 20 according to the present disclosure may be the protrusion detection electrodes 121. The aperture 27 may be long in the planar direction and serve as a groove. The protrusion 127 may be long in the planar direction and serve as an elongated protrusion. While the present embodiment has three types of the protrusion detection electrodes 121 with different numbers of the protrusions 127, the present disclosure simply needs to have two or more types.

While the sensor layer 70 according to the embodiments is a sensor layer made of conductive resin material, for example, the sensor layer according to the present disclosure may be a sensor layer including a deformable insulating body made of silicone rubber or the like and conductive fine particles dispersed in the body. When no force is applied to such a sensor layer, the resistance is high. By contrast, when force is applied to the sensor layer, and the body is deformed, the conductive particles come into contact with or into proximity to each other, and the resistance of the sensor layer decreases. However, the material of the sensor layer according to the present disclosure is limited to material that can be printed on the first surface.

What is claimed is:

1. A detection device comprising
an array substrate and a sensor layer stacked in order, wherein
the array substrate comprises:
a first surface facing the sensor layer; and
a plurality of detection electrodes provided to the first surface and separated from the sensor layer,
the detection electrodes include a plurality of aperture detection electrodes each having an aperture through which the first surface is exposed, and
the aperture detection electrodes include two or more types of the aperture detection electrodes, each type having a different number of the apertures.

2. The detection device according to claim 1, wherein the detection electrodes include a flat detection electrode having a flat shape and not having the aperture.

3. A detection device comprising
an array substrate and a sensor layer stacked in order, wherein
the array substrate comprises:
a first surface facing the sensor layer; and
a plurality of detection electrodes provided to the first surface and separated from the sensor layer,
the detection electrodes include a plurality of protrusion detection electrodes each having a protrusion protruding toward the sensor layer, and
the protrusion detection electrodes include two or more types of the protrusion detection electrodes, each type having a different number of the protrusions.

4. The detection device according to claim 3, wherein the detection electrodes include a flat detection electrode having a flat shape and not having the protrusion.
